(19) United States
(12) Patent Application Publication
(10) Pub. No.: US 2006/0121407 A1
(43) Pub. Date: Jun. 8, 2006

(54) Dental splints and apparatus and method for making dental splints

(76) Inventor: Tim J. Dylina, Meroed, CA (US)

Correspondence Address: LITMAN LAW OFFICES, LTD, PO BOX 15035, CRYSTAL CITY STATION, ARLINGTON, VA, 22215, US

(21) Appl. No.: 11/005,245

(22) Filed: Dec. 7, 2004

(51) Int. Cl. A61C 3/00; A61C 1/00; A61C 5/14

(52) U.S. Cl. 433/25; 128/859

(57) ABSTRACT

The dental splints are used for treating temporomandibular disorders, clenchers, bruxism and headaches resulting from improper alignment of the jaws. The dental splints include a maxillary splint and a mandibular splint. Both splints are formed from stents having a U-shaped trough filled with a dental acrylic and cured in situ on the patient's maxillary teeth and mandibular teeth, respectively. The apparatus includes a maxillary plane analyzer and a holding plate. The holding plate is a U-shaped plate having a central slot for receiving a stem of the plane analyzer and a plurality of recesses for receiving temporary cleats extending from the maxillary stent. The plane analyzer includes a handle, a U-shaped base mounted on the handle and including a pair of arms adapted for extending to either side of the mandible, a stem extending between the arms of the base, and a cruciform upright mounted on the handle.

### BACKGROUND OF THE INVENTION

1. Field of the Invention

The present invention relates to dental devices, and more particularly to an orthotic dental splint, and to an apparatus and method of making the splints to treat temporomandibular disorders, clenchers, bruxism and headaches that can be used by the dentist to make the splints in the dentist's office instead of a dental laboratory.

2. Description of the Related Art

Dental ailments encompass a variety of disorders that require treatment ranging from simple methods to invasive surgery. Temporomandibular disorder (TMD) is one such dental problem. Proper functioning of the lower jaw is dependent, in part, upon temporomandibular joints and associated muscles. The temporomandibular joints are disposed on each side of the jaw and connect the lower jaw to the temporal bones of the skull. The temporomandibular joints (TMJs) are the most used joints in the body; among other functions, the TMJs are used to speak, chew, swallow and yawn. Improper alignment of the lower jaw is recognized by jaw pain, headaches, and other signs and symptoms of discomfort in the patient.

Temporomandibular disorder may be treated using non-invasive techniques, modalities, and devices, such as splints. Invasive measures are usually only resorted to when more conservative measures prove ineffective in relieving the severity of the patient's condition. Splints relieve stress on muscle and joints and often times are used to mitigate the effects of clenching and grinding teeth. Splints may be purchased over the counter. However, more traditionally, splints are custom-made for each patient. Custom-made splints require a procedure having a number of steps, including: first, an impression is made of the patients, maxillary and mandibular teeth using irreversible hydrocolloid or similar product; next, a model is made from the impression; then a bite is taken in wax or a suitable alternative material which articulates the models together in centric relation; finally, the bite model and facebow mounting are sent to a laboratory for fabrication of an upper or lower splint having both maxillary and mandibular impressions. Thus, after a week or less, the patient must return to the office to have the dentist fit the splint in the mouth.

The room for error is vast. If the doctor does not have experience in manipulating the patient in centric relation, errors in splint fabrication can occur. Also, face-bows aligned by pointers or the nasion can be shifted by the patient due to pain or displeasure with the device. Also, new, inexperienced dentists find it difficult to use and balance face-bows, often resulting in such inexperienced dentists opting out of treating TMD because of the difficulty in correcting alignment and finding balance in the temporomandibular joints. Thus, dental splints and an apparatus and method for making the splints that can be easily and quickly done in the office while the patient waits is desired.

### SUMMARY OF THE INVENTION

The dental splints are used for treating temporomandibular disorders, clenchers, bruxism and headaches resulting from improper alignment of the jaws. The dental splints include a maxillary splint and a mandibular splint. Both splints are formed from stents having a U-shaped trough filled with a dental acrylic and cured in situ on the patient's maxillary teeth and mandibular teeth, respectively. The apparatus includes a maxillary plane analyzer and a holding plate. The holding plate is a U-shaped plate having a central slot for receiving a stem of the plane analyzer and a plurality of recesses for receiving temporary cleats extending from the maxillary stent. The plane analyzer includes a handle, a U-shaped base mounted on the handle and including a pair of arms adapted for extending to either side of the mandible, a stem extending between the arms of the base, and a cruciform upright mounted on the handle.

In use, the maxillary stent is positioned on the holder plate by inserting temporary cleats extending from the lower surface of the stent into recesses defined in the holding plate. A dental acrylic is placed in the maxillary stent trough. The holding plate is mounted on the stem of the maxillary plane analyzer. The arms of the analyzer are placed on opposite sides if the patient's mandible, and the analyzer is raised or lowered to align the crossbar of the cruciform upright level with the patient's eyes. This aligns the maxillary stent in the patient's occlusal plane, so that the patient inserts his teeth into the U-shaped trough and the acrylic is allowed to cure, forming a maxillary splint. The analyzer, holding plate, and splint are removed from the patient's mouth, the splint is removed from the holding plate, and the cleats are broken off or removed from the maxillary splint.

The maxillary splint is then inserted into the patient's mouth. Dental acrylic is placed in the U-shaped trough of the mandibular stent, which is then inverted and placed over the mandibular teeth in alignment with the maxillary splint. The acrylic in the mandibular stent is allowed to cure to form the mandibular splint. The mandibular splint is then removed, and any rough surfaces are smoothed. The teeth cavities in the splints cause the patient to maintain the maxilla and the mandible in proper alignment, keeping maximum registry and alignment of the maxillary and mandibular teeth, thereby alleviating the pain associated with TMD, and relieving the patient from pain and discomfort associated with clenching, bruxism, and resulting headaches.

These and other features of the present invention will become readily apparent upon consideration of the following specification and drawings.

### BRIEF DESCRIPTION OF THE DRAWINGS

FIG. 1 is an environmental, perspective view of an apparatus for making dental splints according to the present invention.

FIG. 2 is an exploded perspective view of an apparatus for making dental splints according to the present invention.

FIG. 3 is a front view of an apparatus for making dental splints according to the present invention.

FIG. 4 is a top view of a holding plate according to the present invention.

FIG. 5 is a rear view of a holding plate according to the present invention.

FIG. 6 is a side view of the maxillary stent according to the present invention exploded from the holding plate.

FIG. 7 is a perspective view of a maxillary stent according to the present invention.

FIG. 8 is a perspective view of a mandibular stent according to the present invention.

FIG. 9 is a side view of a maxillary splint according to the present invention.

FIG. 10 is a side view of a mandibular splint according to the present invention.

Similar reference characters denote corresponding features consistently throughout the attached drawings.

### DETAILED DESCRIPTION OF THE PREFERRED EMBODIMENT

The present invention is a pair of dental splints for treating temperomandibular joint disorder and similar conditions involving the relation of the maxilla and mandible, together with an apparatus and method for making dental splints that permits fabricating the splints in the dental practitioner's office instead of a dental laboratory. The structure of the splints will become clear by explaining the apparatus and method of making the splints.

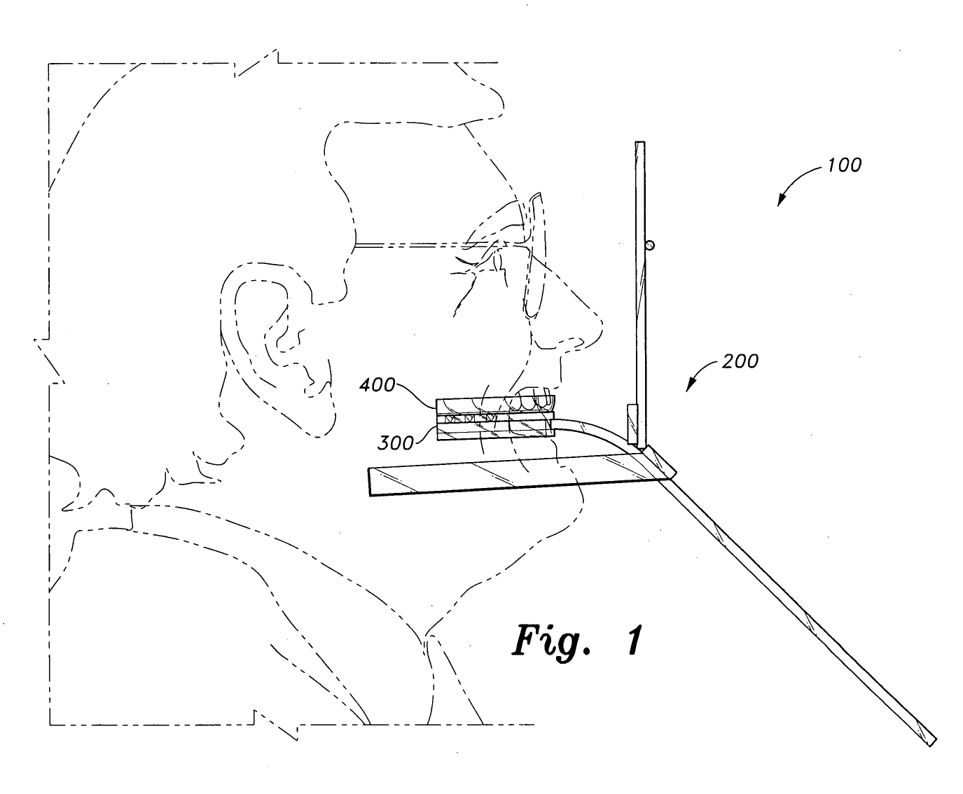

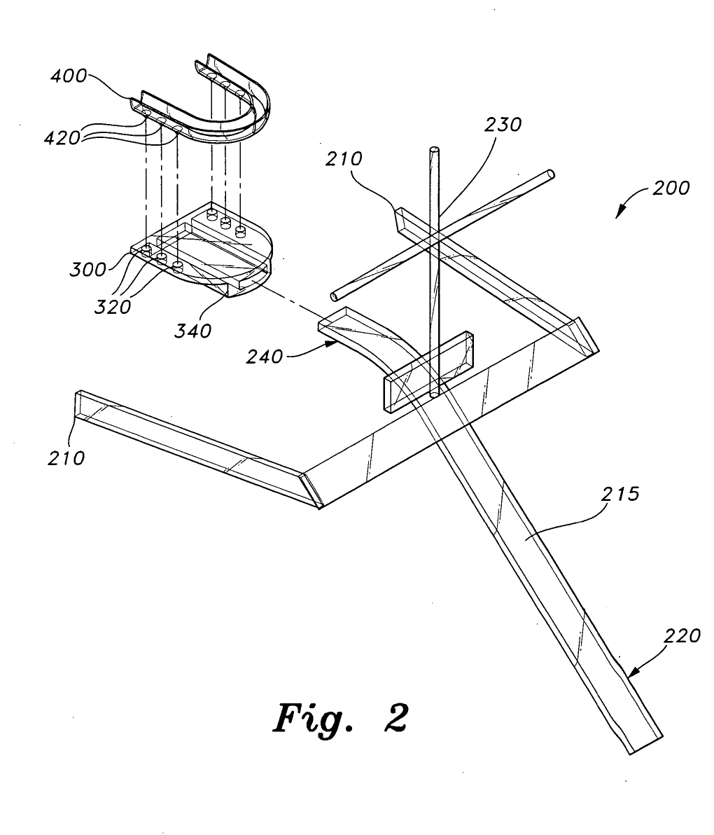

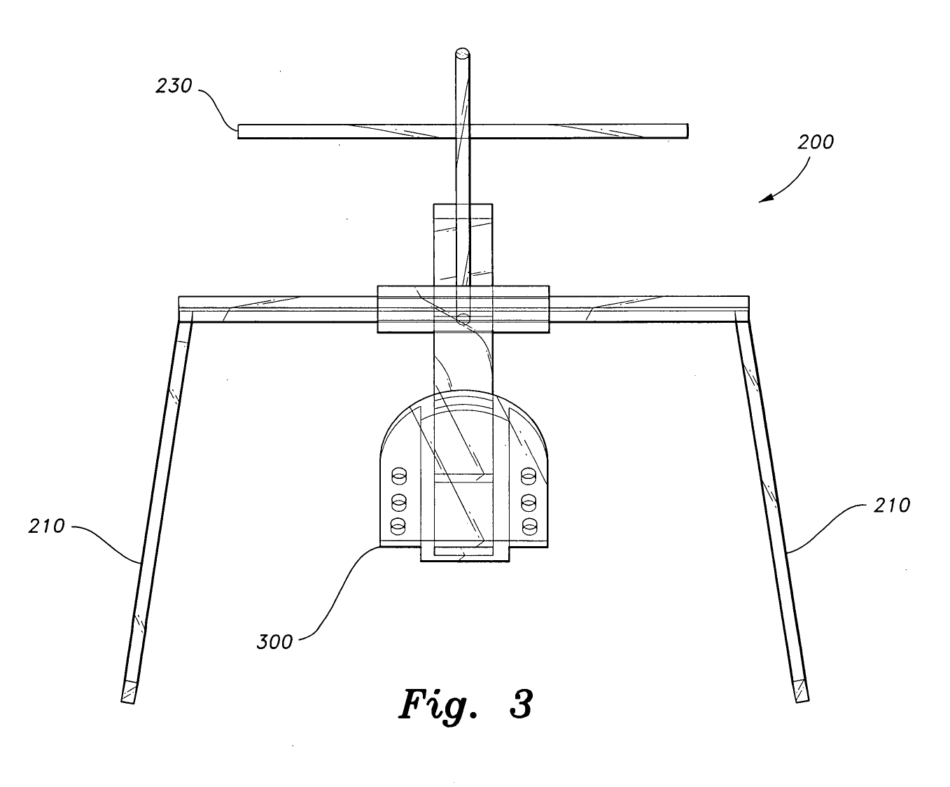

Referring to FIGS. 1, 2 and 3, the apparatus is designated generally as 100 in the drawings. The apparatus 100 includes a maxillary plane analyzer 200, a holding plate 300 and a maxillary stent 400. The holding plate 300 removably holds the stent 400. The dentist uses the analyzer 200 to determine the patient's occlusal plane and orient the stent 400 in the proper angle on the patient's maxilla.

The analyzer 200 is a support and manipulating body having a handle or lever 215, a cruciform upright 230, and a U-shaped base having mandible arms 210. The lever 215 has a curved end or stem 240 and a handle end 220; the upright 230 and mandible arms 210 are disposed adjacent the curved end 240. The mandible arms 210 and the upright 230 serve as orientation guides. The mandible arms 210 are designed to align with the mandible and the crossbar of the cruciform upright 230 is aligned with the patient's eyes, at eyelevel. The lever 215 is arched or bent, allowing a dentist or other user to hold the handle end 220 without obstructing the view of the stem 240. The stem 240 is designed to removably receive and support the holding plate 300.

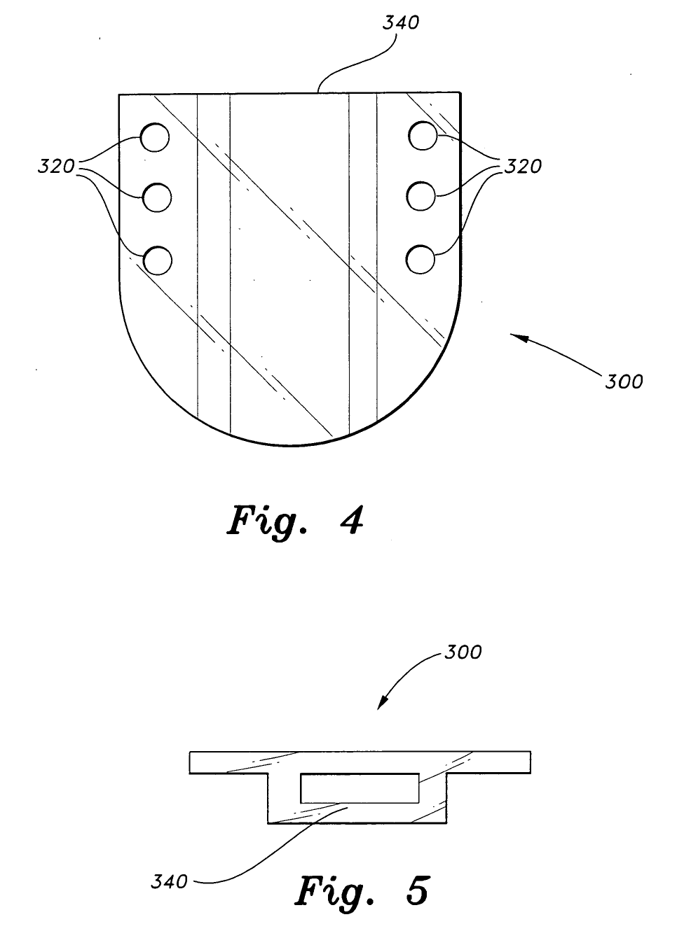

As shown in FIGS. 4 and 5, the holding plate 300 is a generally U-shaped plate having a top surface, a bottom surface, alignment holes 320 or recesses, and a central slot or channel 340 depending from the bottom surface of the plate 300. The channel 340 of the holding plate 300 receives and retains the curved end 240 of the analyzer 200 by friction or by using fasteners, such as snaps, spring loaded attachments, screws, a wingnut, etc. The holding plate 300 removably receives the stent 400, which is retained by the alignment holes 320.

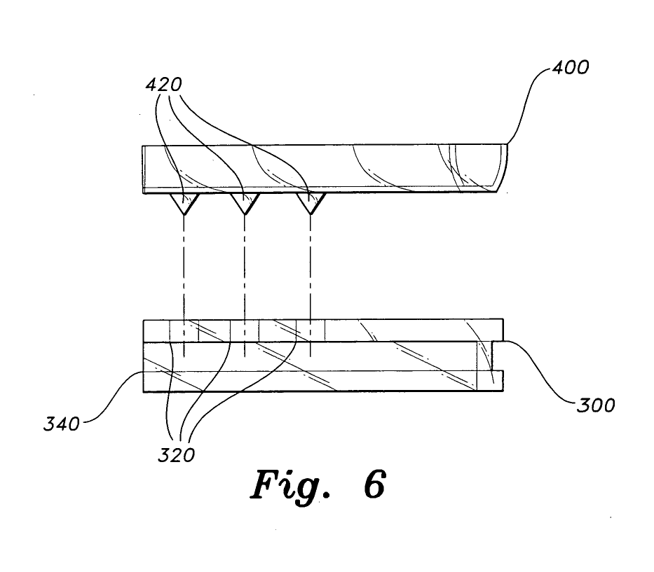

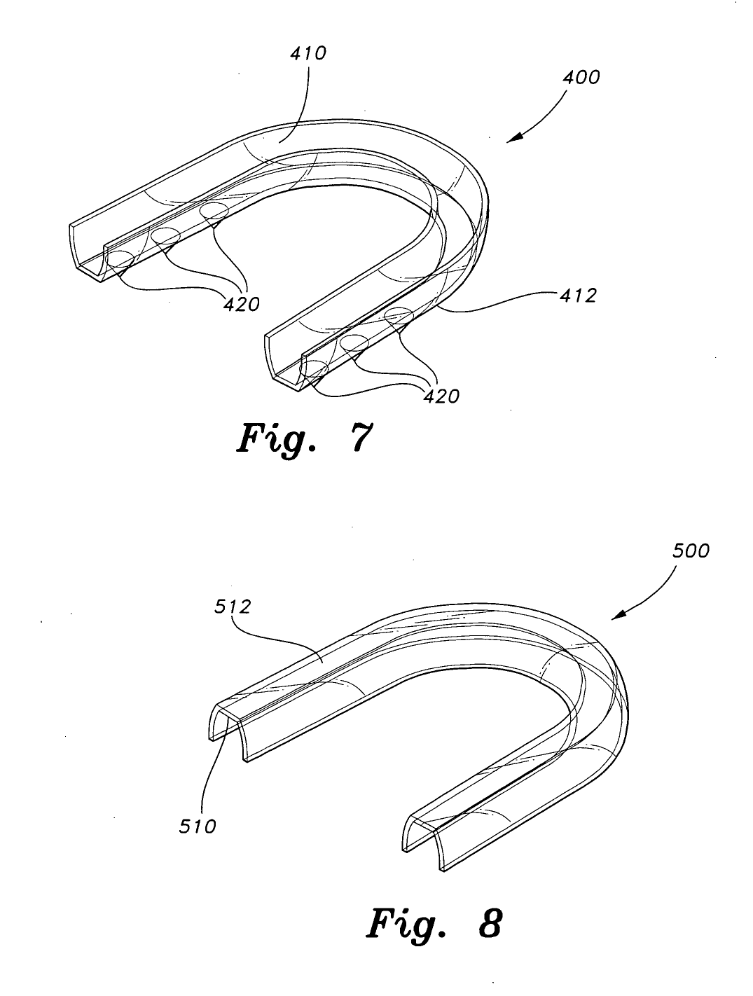

Referring now to FIGS. 6 and 7, a cured maxillary stent 400 provides a frame dimensioned and configured to correspond to the arch of the patient's maxilla. The maxillary stent 400 is made of a hard acrylic, a cured methacrylate, an orthodontic resin, plastic material or other similar material. The stent 400 is a U-shaped frame having a base with an upper side 410 and a lower side 412. A pair of parallel walls extend normal to the upper side 410 of the base to define a U-shaped trough. The trough is designed to fit the arch of the maxilla. The walls of the trough are sufficiently spaced apart to receive an uncured dental acrylic and accommodate the maxillary teeth once the stent frame 400 is placed on the maxilla. The lower side 412 of the stent 400 is flat with cleats 420 extending therefrom.

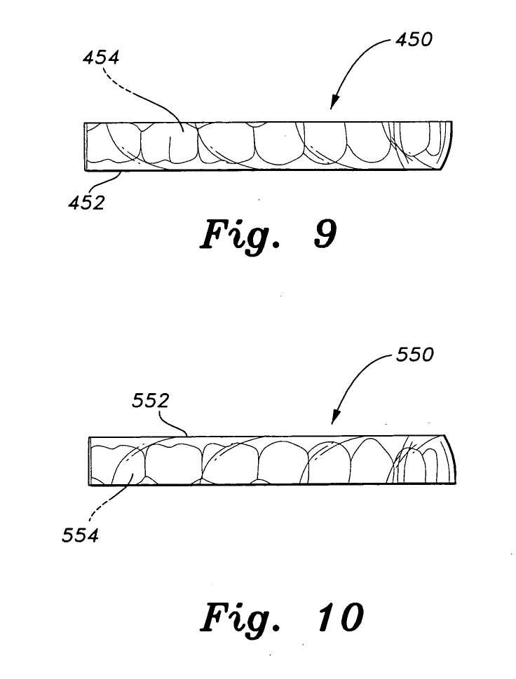

The cleats 420 correspond with the alignment holes 320 of the holding plate 300. The cleats 420 removably hold the cured maxillary stent frame 400 to the holding plate 300 and secure the stent frame 400 as it is delivered into and removed out of the patient's mouth. The cleats 420 are removed once the dental acrylic placed in the stent 400 is cured and the maxillary splint 450, shown in FIG. 9, is formed. The cleats 420 may be any temporary attachment member that correspond with the alignment holes 320 of the holding plate 300. The number of cleats 420 corresponds with the number of alignment holes 320 of the holding plate 300. Although the drawings show six cleats, there is no specific number for each the alignment holes 320 and cleats 420. As an added form of stability, an additional cleat 420 and alignment hole 320 may be disposed in the center of the maxillary stent 400 and the holding plate 300, respectively, nearest the flat end of each. The cleats 420 may be of any shape, such as pyramidal, as shown in the figures, but is preferably cylindrical in shape with a slight six to eight degree taper at the bottom end, which is farthest from the plate 300. Alternatively, instead of cleats 420, the maxillary stent 400 may have a flange, while the holding plate 300 may have a corresponding flange that interconnects to removably connect the stent 400 to the holding plate 300.

To assemble the apparatus 100 and create the maxillary splint 450, the holding plate 300 is removably attached to the curved end 240 of the maxillary plane analyzer 200 by sliding the curved end 240 into the slot or channel 340. The maxillary stent frame 400 is then placed on the holding plate 300 so that the cleats 420 are removably received within the alignment holes 320 of the holding plate 300. Finally, the trough on the upper side 410 of the stent 400 is filled with the uncured methacrylate or other dental acrylic and is oriented on the patient's maxilla using the analyzer 200.

The proper orientation of the stent 400 on the maxilla, and consequentially the proper orientation of a mandibular stent 500 on the mandible, is established when the patient's occlusal plane is located. The analyzer 200 determines the occlusal plane of the patients' mouth based on the occlusal surface of the maxilla. The analyzer has three orientation guides to locate the proper occlusal surface of the maxilla.

The first point of reference places the curved portion 240 of the lever 215 parallel with the occlusal surface of the maxilla. The labial surface of the upper front central incisors are used as reference points. The second orientation guide is based on the alignment of the mandible arms 210 with the patient's mandible. The third orientation guide places the crossbar of the cruciform upright 230 in registry with the eyes, specifically the crossbar of the upright 230 is aligned with an imaginary horizontal line drawn from pupil to pupil. The proper orientation of the maxillary stent 400 on the maxilla is important, because if the occlusal angle is too steep, the maxillary splint 450 will not compensate for the pull of the muscle, and if it is too flat, the problem with the joints would still persist. The occlusal plane angle must conform to the arch of the closure of the mandible to ensure a balance in the system.

The proper occlusal plane of the mouth is based on the maxilla, since the maxilla is stationary, unlike the variable mandible. However it may be possible to determine the proper occlusal plane based on the orientation of the mandible. Once the stent frame 400 is properly oriented on the maxilla, it remains there for a sufficient period of time that the methacrylate, or other dental acrylic, in the trough 410 is cured, thereby forming the maxillary splint 450.

As soon as the maxillary splint 450 is cured, the maxillary splint 450 is removed from the maxilla and the holding plate 300, and the splint is finished. Removing the cleats 420 from the flat side 412 of the stent 400 finishes the splint 450. The maxillary splint 450, shown in FIG. 9, has a flat lower surface 452, the cleats 420 being removed from the maxillary stent 400, and maxillary teeth impressions 454 formed by cured acrylic in the trough side 410 of the maxillary stent 400. The maxillary splint 450 is then replaced on the maxilla and a mandibular stent 500 is prepared and positioned on the mandible.

As shown in FIG. 8, the mandibular stent 500 is a U-shaped frame and is generally dimensioned and configured to correspond to the arch of the patient's mandible. The mandibular stent 500 has a U-shaped base having a first side and a second side. The lower side has parallel walls extending from the base creating a trough side 510; the upper side 512 of the base is flat. The mandibular stent 500 is made of a hard acrylic, a cured methacrylate, an orthodontic resin, plastic material or other similar material. The trough side 510 of the mandibular stent 500, like the maxillary stent 400, receives a quantity of uncured methacrylate or other dental acrylic, and the stent 500 is then disposed on the patient's mandible and cured in place.

The proper occlusal surface for the mandibular stent 500 is determined based on the position of the mandibular stent 500 relative to the maxillary splint 450. As mentioned above, the analyzer 200 determines the occlusal plane of the patient's mouth based on the occlusal surface of the maxilla. Thus, when the maxillary splint 450 is disposed on the maxillary splint 400, the maxillary splint 450 acts as the orientation guide for the mandibular stent 500 and consequentially defines the proper occlusal plane for both splints 450 and 550. To orient the mandibular stent 500 on the mandible, the flat surface 512 of the mandibular stent 500 abuts the flat lower surface 452 of the cured maxillary splint 450. As with the maxillary splint 450, the mandibular stent 500 remains on the mandible for a sufficient period of time to cure the methacrylate or other dental acrylic disposed in the trough 510 of the mandibular stent 500, and an impression of the mandibular teeth is obtained, thereby creating the mandibular splint 550. The mandibular splint 550, shown in FIG. 10, has a flat upper surface 552 and mandibular teeth impressions 554 formed by curing the methacrylate or other dental acrylic in the trough or lower side 510 of the mandibular stent 500. Once cured, the mandibular splint 550 is removed from the mandible and finished by smoothing out any sharp edges. The entire process should take less than thirty minutes.

The stents 400, 500 are differentiated from the splints 450, 550, in that the stents 400, 500 are a frame made to receive the uncured acrylic. The splints 450, 550 are the final product used to determine the occlusal surface and the occlusal plane, and have teeth impressions 454, 554 formed therein.

The proper occlusal plane is achieved when the majority of the maxillary teeth are in contact with the majority of the mandibular teeth so that the temporomandibular joint is resting and relaxed. Since the proper occlusal plane had been determined by the orientation of the maxillary splint 450 to the maxilla using the analyzer 200, the flat side 452 of the maxillary splint 450 demarcates the proper occlusal plane and the proper orientation of the flat side 552 of the mandibular splint 550 in the jaw. Therefore, when the splints 450, 550 are used together, the splints 450 and 550 ensure that a majority of teeth will be in contact with each other when the jaw is closed, thereby lessening the burden placed on the temporomandibular joints and relaxing the elevator and positioning muscles. The maxillary splint 450 and the mandibular splint 550.are best used together, but may be used alone as individual pieces.

The method for making dental splints includes creating the maxillary splint 450 in situ on the maxilla of the patient and creating the mandibular splint 550 in situ on the mandible of the patient. First the maxillary plane analyzer 200 is prepared by joining the holding plate 300 to the lever 215. The maxillary stent frame 400 with uncured dental acrylic in the trough is placed on the holding plate 300. The maxillary stent 400 is then oriented on the patient's maxilla at the proper occlusal plane using the maxillary plane analyzer 200. The uncured acrylic disposed in the trough side 410 of the maxillary stent 400 is cured in place on a patient's maxilla to take the impression from the teeth. The maxillary stent 400 is then removed from the maxilla and finished by removing the cleats 420 and smoothing off any sharp edges to create the maxillary splint 450.

Next, the mandibular stent 500 is placed on the mandible and cured in situ based on the orientation of the mandibular stent 500 to the patient's occlusal plane as demarcated by the flat surface 452 of the maxillary splint 450. The maxillary splint 450 is replaced on the maxilla before the mandibular stent 500, having a quantity of uncured dental acrylic in the trough side 512, is oriented on the patient's mandibular teeth. Finally, the acrylic in the trough side 512 is cured in place on the mandible to the shape of the mandibular teeth, thereby forming the mandibular splint 550. As with the maxillary splint 450, the mandibular splint 550 is finished by smoothing out rough edges.

It is to be understood that the present invention is not limited to the embodiment described above, but encompasses any and all embodiments within the scope of the following claims.

I claim:

1. An apparatus for making dental splints, comprising:
a maxillary plane analyzer including a lever having a handle end and a curved end forming a stem; and
a U-shaped holding plate having a top surface and a bottom surface, a channel depending from the bottom surface, and means for retaining a stent on the top surface, the stem of the analyzer being removably inserted in the channel to support the holding plate.

2. The apparatus of claim 1, further comprising a U-shaped base mounted on the lever between the handle and the stem, the base having a pair of mandible arms extending parallel with the stem.

3. The apparatus of claim 2, further comprising a cruciform upright having a crossbar, the upright being mounted on the lever and extending normal to the base.

4. The apparatus of claim 1, further comprising a maxillary stent, the maxillary stent frame being a U-shaped base having an upper side and a lower side, the base having a pair of parallel walls extending from the upper side and forming a U-shaped trough adapted for placement over a patient's maxillary teeth, the lower side of the base being flat and having means for attachment to said holding plate, the means for attachment being removable from the lower surface.

5. The apparatus of claim 4, wherein said retaining means comprises a plurality of alignment holes defined in the top surface of said holding plate and said attaching means comprises a plurality of cleats depending from the lower surface of said maxillary stent, the cleats being received in the alignment holes.

6. The apparatus of claim 1, wherein the maxillary stent frame is made of hardened dental acrylic.

7. The apparatus of claim 4, further comprising a U-shaped mandibular stent made of hardened dental acrylic and having a flat upper surface and a lower surface with a pair of parallel walls extending from the lower surface defining a U-shaped trough adapted for placement over a patient's mandibular teeth.

8. A method for relieving stress on the jaws in the treatment of temporomandibular joint disease, comprising the steps of:
(a) placing a quantity of an uncured acrylic into a U-shaped trough of a maxillary stent;
(b) placing the maxillary stent over a patient's maxillary teeth; and
(c) curing the maxillary stent in situ to form a maxillary splint.

9. The method of claim 8, wherein step (b) further comprises the steps of:
locating a patient's occlusal plane using a maxillary plane analyzer; and
aligning the maxillary stent over the patients' maxillary teeth in the occlusal plane.

10. The method of claim 8, further comprising the steps of:
(d) placing a quantity of an uncured acrylic into a U-shaped trough of a mandibular stent;
(e) placing the mandibular stent over a patient's mandibular teeth; and
(f) curing the mandibular stent in situ to form mandibular splint.

11. The method of claim 10, wherein the mandibular splint is made after the maxillary splint is made.

12. The method of claim 10, wherein step(e) further comprises the step of aligning the mandibular stent with said maxillary splint in order to align the patient's maxillary teeth with the patient's mandibular teeth in the occlusal plane.

13. A maxillary splint and a mandibular splint formed according to the method of claim 10.

14. A dental splint, comprising:
a U-shaped maxillary stent made from hardened dental acrylic having a flat, U-shaped base with an upper side and a lower side and a pair of parallel walls extending from the upper side and forming a U-shaped trough, the lower side of the base having removable means for attachment to a holding plate extending therefrom;
a maxillary teeth mold formed and cured in situ in the U-shaped trough from a dental acrylic in order to form a maxillary splint.

15. The dental splint of claim 14, wherein the maxillary stent is made of a cured methacrylate.

16. The dental sprint according to claim 14, wherein said means for attachment comprises a plurality of cleats.

17 The dental splint of claim 14, further comprising:
a U-shaped mandibular stent made from hardened dental acrylic having a flat, U-shaped base with an upper side and a lower side and a pair of parallel walls extending from the lower side and forming an inverted U-shaped trough;
a mandibular teeth mold formed and cured in situ in the inverted U-shaped trough from a dental acrylic in order to form a mandibular splint, the mandibular splint being aligned with the maxillary splint when the splints are placed in a patient's mouth.

18. The dental splint of claim 17, wherein the dental acrylic is methacrylate.
